(19) United States
(12) Patent Application Publication
(10) Pub. No.: US 2026/0019161 A1
(43) Pub. Date: Jan. 15, 2026

(54) Optical Frequency Hopping for Channel Presence Detection in an Optical Network

(71) Applicant: II-VI Delaware, Inc., Wilmington, DE (US)

(72) Inventors: Harald Rosenfeldt, Picnic Point (AU); Yajun Wang, Naperville, IL (US); Kenneth Jay Falta, McMurray, PA (US)

(21) Appl. No.: 18/771,590

(22) Filed: Jul. 12, 2024

(51) Int. Cl. H04B 10/64; H04B 1/713

(52) U.S. Cl. CPC H04B 10/64; H04B 1/713

(57) ABSTRACT

An optical channel monitor (OCM) and method of use of the OCM for detecting for degradation of optical channels in an optical fiber communication system, includes: (a) heterodyne sampling from an optical fiber an optical signal with light from a light source that changes frequency over time at a constant slope; (b) pausing the sampling of step (a); (c) following step (b), heterodyne sampling, by frequency hopping, the optical signal with light from the light source; (d) concurrent with step (c), sampling, by a controller, a response of the optical signal to each frequency hop in step (c); and (e) in response to at least one sample in step (d) being determined by the controller to be outside of a predetermined tolerance or range for the sample, the controller generating an error signal.

### BACKGROUND

### Field

The present disclosure relates to a system and method of channel presence detection in an optical network.

### Background

With reference to FIG. 1, an example prior art test scan by an internal laser of an optical channel monitor (OCM), that includes an OCM controller and an OCM internal laser, to detect for channel loss(es) of a sampled optical signal may include a piecewise linear optical (or laser) signal 2, an example of which is shown in FIG. 1. In an example, the prior art test scan may include the sampled optical signal being mixed (or heterodyned) with the piecewise linear optical (or laser) signal 2. Hereinafter, the “sampled optical signal” may be referred to a/the “optical signal.”

In one non-limiting example, the piecewise linear optical signal 2 may have a slope of 125MHz/microsecond and the OCM controller may be programmed, operative and/or configured to cause the OCM’s internal laser to switch to a different laser mode after a scan of a predetermined frequency range, such as, for example, 100GHz as shown in Fig.1.

In an example, the piecewise linear optical signal 2 may include, for example, sections 4-1 through 4-5, each of which may cover a frequency range of, for example, 100GHz that is scanned over a period of, for example, 1ms, with a gap 6 between adjacent sections 4. In this example, the piecewise linear optical signal 2 may include a gap 6-1 between sections 4-1 and 4-2, a gap 6-2 between sections 4-2 and 4-3, a gap 6-3 between sections 4-3 and 4-4, and a gap 6-4 between sections 4-4 and 4-5.

In an example, the piecewise linear optical signal 2 may also include an overlap 8 of frequencies, e.g., 10 GHz, between adjacent sections 4, e.g., overlap 8-1 between sections 4-1 and 4-2, overlap 8-2 between sections 4-2 and 4-3, overlap 8-2 between sections 4-3 and 4-4, and overlap 8-2 between sections 4-4 and 4-5. In an example, the OCM controller may programmed, operative and/or configured with a stitching algorithm that may be used to cause the OCM’s internal laser to output the piecewise linear optical signal 2 with the gaps 6 and overlaps 8 between adjacent sections 4.

During the scan of the piecewise linear optical signal 2, the OCM controller may, during the application of the piecewise linear optical signal 2 to the optical signal, continuously, periodically or aperiodically sample the response to the mixing (or heterodyning) of the optical signal and the piecewise linear optical signal 2 and compare each sample to a predetermined tolerance or range for the sample. In an example, the sampled response may be the power at each sampled frequency.

If, based on the comparison, the OCM controller determines that the power at one or more sampled frequencies is outside the predetermined tolerance or range for said one or more samples (e.g., the power of a sample is ≤ 80% of an expected sampled power), the OCM controller may output a suitable error signal of this event that may be used for investigating and/or correcting the condition(s) that caused the error signal to be generated.

In an example, the piecewise linear optical signal 2 may include 50-80 sections 4, wherein each section 4 may include a number of channels, and a total scan time of the piecewise linear optical signal 2 may be around 500ms. Upon completion of a scan of the optical signal with the piecewise linear optical signal 2 from a beginning frequency 10 to an end frequency 12, the OCM controller may cause the OCM laser repeat another scan of the optical signal with the piecewise linear optical signal 2 from the beginning frequency 10 to the end frequency 12. In an example, the OCM controller may continuously, periodically or aperiodically scan the optical signal with the piecewise linear optical signal 2

An optical network gets disturbed when a group, e.g., 16 – 24, of channels suddenly drop(s) in power. It would be desirable to detect these sudden drop(s) in power in a time frame quicker than the total scan time (~ 500ms) of the piecewise linear optical signal 2 shown FIG. 1

### SUMMARY

Disclosed herein is a method of detecting for degradation of optical channels in an optical communication system, the method comprising: (a) heterodyne sampling an optical signal with light from a light source that changes its optical frequency over time at a constant slope; (b) pausing the sampling of step (a); (c) following step (b), heterodyne sampling, by frequency hopping, the optical signal with light from the light source; (d) concurrent with step (c), sampling, by a controller, a response of the optical signal to each frequency hop in step (c); and (e) in response to at least one sampled frequency hop in step (d) being determined by the controller to be outside of a predetermined tolerance or range for the sampled frequency hop, the controller generating an error signal. In an example, each step of heterodyne sampling may comprise mixing the optical signal with the light from the light source that (1) changes frequency over time at a constant slope in step (a) and/or (2) changes frequency by frequency hopping in step (c).

Also disclosed herein is an optical channel monitor (OCM) programmed, operative and/or configured to perform a method of detecting for degradation of optical channels in an optical communication system, the method comprising: (a) heterodyne sampling (or mixing) an optical signal (e.g., sampled from an optical fiber) with light from a light source that changes frequency over time at a constant slope; (b) pausing the sampling of step (a); (c) following step (b), heterodyne sampling, by frequency hopping, the optical signal with light from the light source; (d) concurrent with step (c), sampling, by a controller, a response of the optical signal to each frequency hop in step (c); and (e) in response to at least one sampled frequency hop in step (d) being determined by the controller to be outside of a predetermined tolerance or range for the sampled frequency hop, the controller generating an error signal. In an example, each step of heterodyne sampling may comprise mixing the optical signal with the light from the light source that (1) changes frequency over time at a constant slope in step (a) and/or (2) changes frequency by frequency hopping in step (c).

### BRIEF DESCRIPTION OF THE DRAWINGS

FIG. 1 is a non-limiting embodiment or example of a prior art piecewise linear optical signal that may be mixed or heterodyned with an optical signal of an optical network to detect for drop(s) in power occurring in the optical signal;

FIG. 2 is a non-limiting embodiment or example schematic of an optical network including an optical fiber and an exemplary optical channel monitor, e.g., an optical heterodyne channel monitor, (OCM) coupled to the optical fiber that may be used to sample the optical signal from the optical fiber, in accordance with the principles of the present disclosure;

FIG. 3A is a non-limiting embodiment or example graph of an optical test signal, in accordance with the principles of the present disclosure, showing frequency hopping scans that may be mixed or heterodyned by the OCM with the optical signal sampled from the optical fiber shown in FIG. 2 between adjacent sections of a piecewise linear optical signal scan;

FIG. 3B is an enlarged view of a portion of the example optical test signal of FIG. 3A showing details of one frequency hopping scan that that may be mixed or heterodyned by the OCM with the optical signal between adjacent sections of the piecewise linear optical signal scan; and

FIG. 4 is a method in accordance with the principles of the present disclosure.

### DETAILED DESCRIPTION

Various non-limiting embodiments will now be described with reference to the accompanying figures where like reference numbers correspond to like or functionally equivalent elements or features.

As used herein, spatial, or directional terms, such as “left”, “right”, “inner”, “outer”, “above”, “below”, and the like, relate to the disclosure as it is shown in the drawing figures. However, it is to be understood that the disclosure can assume various alternative orientations and, accordingly, such terms are not to be considered as limiting. Further, as used herein, all numbers expressing dimensions, physical characteristics, processing parameters, quantities of ingredients, reaction conditions, and the like, used in the specification and claims are to be understood as being modified in all instances by the term “approximately” or “about.” Accordingly, unless indicated to the contrary, the numerical values set forth in the following specification and claims may vary depending upon the desired properties sought to be obtained by the present disclosure.

At the very least, and not as an attempt to limit the application of the doctrine of equivalents to the scope of the claims, each numerical value should at least be construed in light of the number of reported significant digits and by applying ordinary rounding techniques. Moreover, all ranges disclosed herein are to be understood to encompass the beginning and ending range values and any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, e.g., 1 to 3.3, 4.7 to 7.5, 5.5 to 10, and the like. “A” or “an” refers to one or more.

As used herein, "coupled", "coupling", and similar terms refer to two or more elements that are joined, linked, fastened, connected, put in communication, or otherwise associated (e.g., mechanically, electrically, fluidly, optically, electromagnetically) with one another. In various examples, the elements may be associated directly or indirectly. As an example, element A may be directly associated with element B. As another example, element A may be indirectly associated with element B, for example, via another element C. It will be understood that not all associations among the various disclosed elements are necessarily represented. Accordingly, couplings other than those depicted in the figures may also exist.

As used herein, the phrase "at least one of", when used with a list of items, means different combinations of one or more of the listed items may be used and only one of each item in the list may be needed. For example, "at least one of item A, item B, and item C" may include, without limitation, item A or item A and item B. This example also may include item A, item B, and item C, or item B and item C. In other examples, "at least one of" may be, for example, without limitation, two of item A, one of item B, and ten of item C; four of item B and seven of item C; and other suitable combinations.

In this disclosure, each item, element, circuit and/or system described as being “programmed, operative and/or or configured” may be formed of:

(1) one or more discrete passive optical and/or electrical components, such as, without limitation, laser source(s), optical waveguide(s), resistor(s), capacitor(s), inductor(s), transistor(s), op-amp(s), and the like in some combination thereof as determined by the application; or

(2) one or more controller(s), processor(s), memory, storage component(s), an input component, an output component, and a communication interface, all connected by a bus in some combination thereof as determined by the application; or

(3) some combination of (1) and (2) as determined by the application.

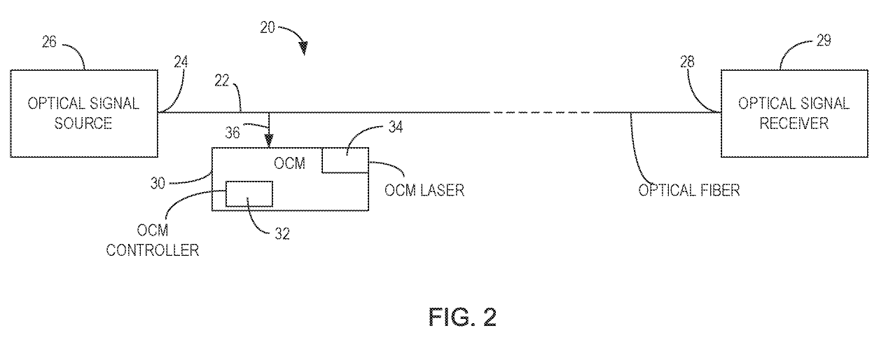

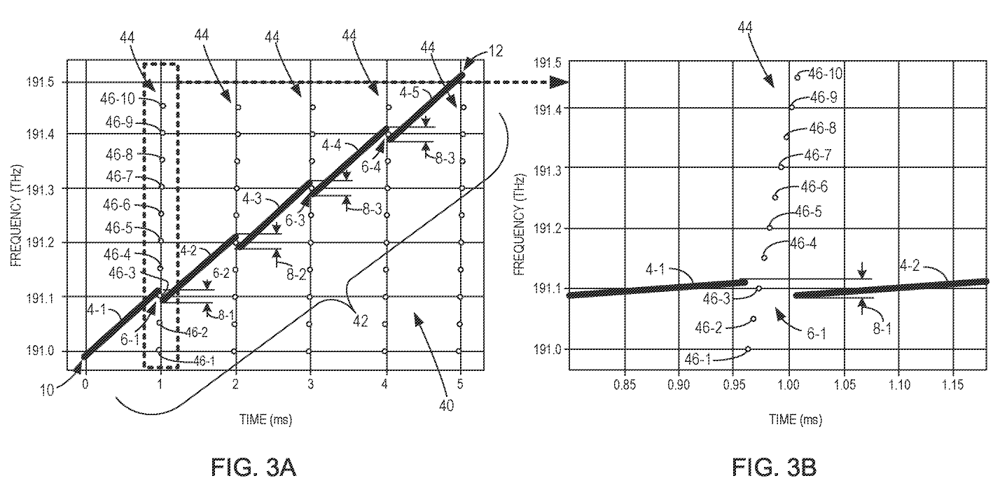

With reference to FIGS. 2-3B, an optical network or system 20 in accordance with the principles of the present disclosure may include an optical fiber 22, e.g., an Erbium doped optical fiber amplifier (EDFA), having an input end 24 coupled to receive an optical (e.g., laser) signal from an upstream optical signal source 26 and an output end 28 coupled to provide the optical signal propagating in the optical fiber 22 to a downstream optical signal receiver 29.

In accordance with the principles of the present disclosure, the optical system 20 may include an optical channel monitor (OCM) 30 that includes an OCM controller 32 and an OCM laser or optical source 34. The OCM 30 may also include additional, unillustrated elements, that have been omitted for simplicity, that enable or facilitate the OCM 30 performing the various functions or operations described in this disclosure.

The OCM 30 may be coupled, e.g., via an optical splitter, at 36 to sample optical signals output by the optical signal source 26 for propagation in the optical fiber 22. The illustration in FIG. 2 of the OCM 30 coupled to the optical fiber 22, however, is not to be construed in a limiting sense since it is envisioned that the OCM 30 may be coupled to any suitable and/or desirable location of the disclosed optical system 20 between and including the optical signal source 26, the optical fiber 22 (as shown in FIG. 2), or the optical signal receiver 29.

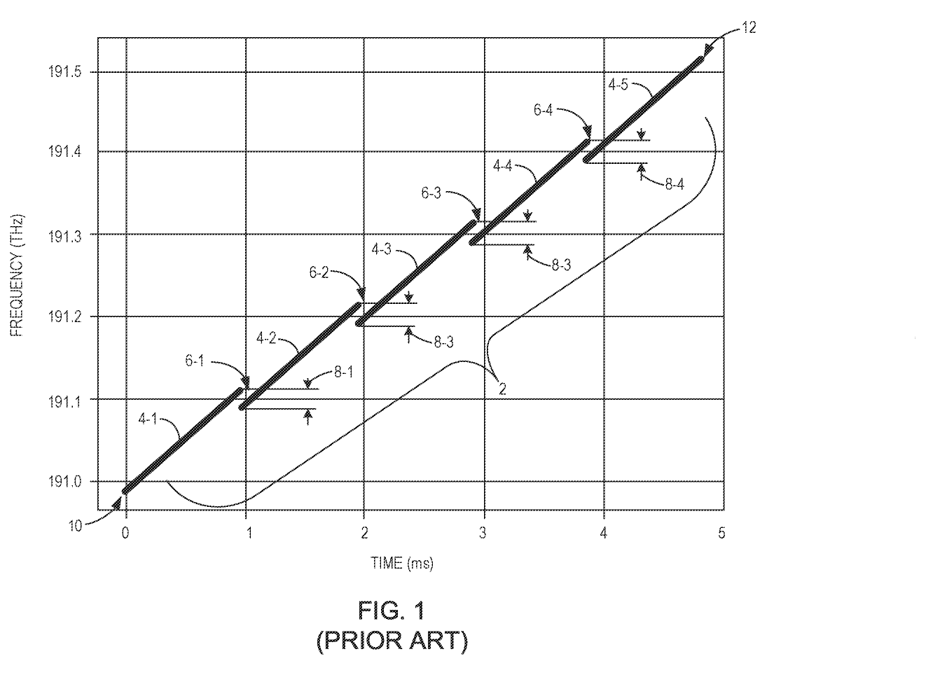

An optical test scan 40, generated by the OCM laser 34 under the control of the OCM controller 32, may be mixed (or heterodyned) with the optical signals sampled from the optical fiber 22. The optical test scan 40 may comprise a piecewise linear optical signal portion 42 shown in FIG. 3A, like the piecewise linear optical signal 2 shown in FIG. 1 and described in the Background of this disclosure, and may also comprise a frequency hopping scan portion 44 in each gap 6 between adjacent sections 4 of the piecewise linear optical signal portion 42. In this disclosure, like elements or features of the piecewise linear optical signal 2 in FIG. 1 and the piecewise linear optical signal portion 42 will be described using like reference numbers.

In an example, each frequency hopping portion 44 may include a number or plurality of channels 46 that is/are mixed (or heterodyned) with the optical signals sampled from the optical fiber 22 by the OCM controller 32. In the example shown in FIGS. 3A and 3B, each frequency hopping portion 44 may include channels 46-1 through 46-10 separated by hops of 0.5 THz between frequencies 191.0 THz and 191.45 THz. However, this example is not to be construed in a limiting sense since the number of channels 46 and/or the separation or hop, e.g., of 0.5 THz, between each pair of adjacent channels 46 may be the same or different than illustrated in FIGS. 3A and 3B and may be selected, as may be deemed suitable and/or desirable, for a particular application. Stated differently, the separation or hop of 0.5 THz between adjacent channels 46 shown in FIGS. 3A and 3B is not to be construed in a limiting sense since it is envisioned that the separation or hop between each pair of adjacent channels 46 may be the same or different, e.g., 0.05 THz, 0.4 THz, 0.6 THz, 1 THz. etc.

Moreover, the range of frequencies versus time (in milliseconds) of each graph shown in FIGS. 1, 3A and 3B are strictly for the purpose of illustration and are not to be construed in a limiting sense since the range of frequencies to be scanned with the piecewise linear optical signal portion 42 including the frequency hopping scan portion 44 (including the number or quantity of channels 46 and/or the separation or hop between each pair of adjacent channels 46) in each gap 6 between adjacent sections 4 of the piecewise linear optical signal portion 42 may be selected as deemed suitable and/or desirable for the band or bands of channels under test. For example, assuming the optical fiber is tested for an optical signal in the C-band having wavelengths that may typically range from approximately 1530 nm to 1565 nm, the piecewise linear optical signal portion 42 may range from a beginning frequency 10 of 191 THz to an end frequency 12 of 196 THz. This example, however, is strictly for the purpose of illustration and is not to be construed in a limiting sense.

Moreover, if the optical fiber 22 is tested for multiple bands, e.g., two or more of the C-band, the L-band and/or the S-band, the piecewise linear optical signal portion 42 including the range of frequencies between the beginning frequency 10 and the end frequency 12, the quantity of channels 46, and/or the frequency spacing between each channel 46 in each gap 6 between adjacent sections 4 of the piecewise linear optical signal portion 42 may be selected as deemed suitable and/or desirable for each band.

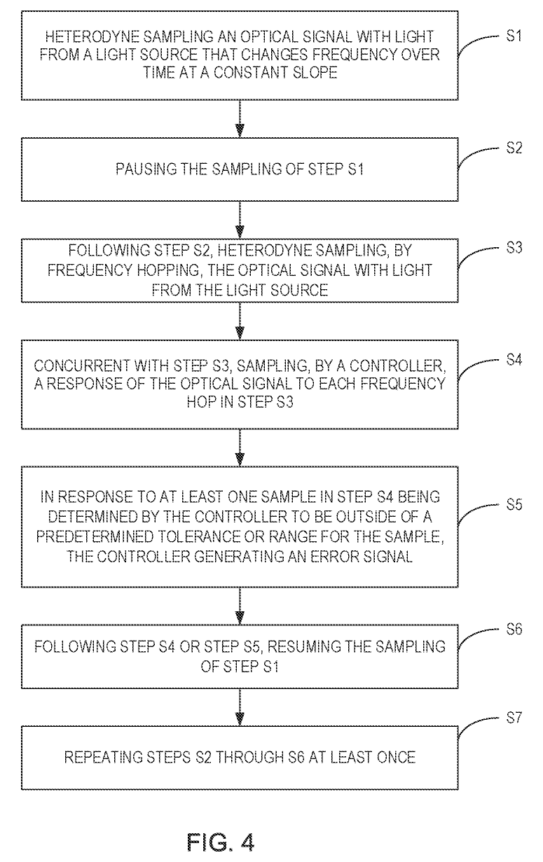

With reference to FIG. 4 and with continuing reference to FIG. 2-3B, a method, in accordance with the principles of the present disclosure, of detecting for degradation of optical channels in an optical fiber communication system includes a step S1 heterodyne sampling (or mixing) an optical signal (sampled from the optical fiber 22) with light from a light source, e.g., the laser 34 of the OCM 30, that changes frequency over time at a constant slope. In step S2 the sampling of step S1 is paused. Following step S2, in step S3 the optical signal is heterodyne sampled, by frequency hopping, the optical signal with light from the light source.

Concurrent with steps S3, in step S4 a response of the optical signal to each frequency hop in step S3 is sampled by a controller, e.g., the OCM controller 32. In step S5, in response to at least one sample in step S4 being determined by the controller to be outside of a predetermined tolerance or range for the sample, the controller generates an error signal. This error signal may be a human detectable optical and/or an audible warning or signal, and/or an electronic signal that may be detectable by another electronic system that may generate a subsequent human detectable optical and/or an audible warning or signal.

The method may further include a step S6 wherein, following step S4 (when each sample is within the predetermined tolerance or range for the sample) or step S5 (when at least one sample is outside of a predetermined tolerance or range for the sample), the scan of step S1 is resumed. Finally, in step S7, steps S2 through S6 are repeated at least once.

In an example, in step S6, the scan may be resumed at a frequency that overlaps a frequency of the scan when the scanning was paused in step S2. In an example, each instance of the period of scanning in step S1 and/or in step S6 may be the same or different. In an example, a difference between adjacent frequency hops in step (c) may be the same or different.

Other non-limiting examples or aspects of this disclosure are set forth in the following illustrative and exemplary numbered clauses:

Clause 1: A method of detecting for degradation of optical channels in an optical fiber communication system, the method comprising: (a) heterodyne sampling an optical signal with light from a light source that changes frequency over time at a constant slope; (b) pausing the sampling of step (a); (c) following step (b), heterodyne sampling, by frequency hopping, the optical signal with light from the light source; (d) concurrent with step (c), sampling, by a controller, a response of the optical signal to each frequency hop in step (c); and (e) in response to at least one sample in step (d) being determined by the controller to be outside of a predetermined tolerance or range for the sample, the controller generating an error signal. In an example, each step of heterodyne sampling may comprise mixing the optical signal (which may be sampled from an optical fiber) with the light from the light source that (1) changes frequency over time at a constant slope in step (a) and/or (2) changes frequency by frequency hopping in step (c).

Clause 2: The method of clause 1, wherein step (a) includes continuously, periodically or aperiodically sampling and comparing each sample in step (a) to a predetermined tolerance or range for the sample.

Clause 3: The method of clause 1 or 2, further comprising (f) following step (d) or step (e), resuming the sampling of step (a), i.e., resuming or continuing the sampling of step (a) where it was paused in step (b). In an example of this step (f), the sampling of step (a) may be resumed following step (d) when each sample is within a predetermined tolerance or range for the sample. In another example of this step (f), the sampling of step (a) may be resumed following step (e) when at least one sample is outside of a predetermined tolerance or range for the sample.

Clause 4: The method of any one of clauses 1-3, further comprising (g) repeating steps (b) - (f) at least once.

Clause 5: The method of any one of clauses 1-4, wherein, in step (f), the sampling is resumed at a frequency that overlaps a frequency of the sampling when the sampling was paused in step (b).

Clause 6: The method of any one of clauses 1-5, wherein each instance of step (b) occurs after a period of sampling in step (a) or a period of sampling following step (f).

Clause 7: The method of any one of clauses 1-6, wherein each instance of the period of sampling in step (a) or step (f) is the same.

Clause 8: The method of any one of clauses 1-7, wherein each instance of the period of sampling in step (a) or step (f) is different.

Clause 9: The method of any one of clauses 1-8, wherein a difference between adjacent frequency hops in step (c) is the same.

Clause 10: The method of any one of clauses 1-9, wherein a difference between adjacent frequency hops in step (c) is different.

Clause 11: An optical channel monitor (OCM) programmed, operative and/or configured to perform a method comprising: (a) heterodyne sampling an optical signal with light from a light source that changes frequency over time at a constant slope; (b) pausing the sampling of step (a); (c) following step (b), heterodyne sampling, by frequency hopping, the optical signal with light from the light source; (d) concurrent with step (c), sampling, by a controller, a response of the optical signal to each frequency hop in step (c); and (e) in response to at least one sample in step (d) being determined by the controller to be outside of a predetermined tolerance or range for the sample, the controller generating an error signal. In an example, each step of heterodyne sampling may comprise mixing the optical signal (which may be sampled from an optical fiber) with the light from the light source that (1) changes frequency over time at a constant slope in step (a) and/or (2) changes frequency by frequency hopping in step (c).

Clause 12: The OCM of clause 11, wherein step (a) includes continuously, periodically or aperiodically sampling and comparing each sample in step (a) to a predetermined tolerance or range for the sample.

Clause 13: The OCM of clause 11 or 12, wherein the method further comprises (f) following step (d) or step (e), resuming the sampling of step (a), i.e., resuming or continuing the sampling of step (a) where it was paused in step (b). In an example of this step (f), the sampling of step (a) may be resumed following step (d) when each sample is within a predetermined tolerance or range for the sample. In another example of this step (f), the sampling of step (a) may be resumed following step (e) when at least one sample is outside of a predetermined tolerance or range for the sample.

Clause 14: The OCM of any one of clauses 11-13, wherein the method further comprises (g) repeating steps (b) – (f) at least once.

Clause 15: The OCM of any one of clauses 11-14, wherein, in step (f), the sampling is resumed at a frequency that overlaps a frequency of the sampling when the sampling was paused in step (b).

Clause 16: The method of any one of clauses 11-15, wherein each instance of step (b) occurs after a period of sampling in step (a) or a period of sampling following step (f).

Clause 17: The method of any one of clauses 11-16, wherein each instance of the period of sampling in step (a) or step (f) is the same.

Clause 18: The method of any one of clauses 11-17, wherein each instance of the period of sampling in step (a) or step (f) is different.

Clause 19: The method of any one of clauses 11-18, wherein a difference between adjacent frequency hops in step (c) is the same.

Clause 20: The method of any one of clauses 11-19, wherein a difference between adjacent frequency hops in step (c) is different.

Although this disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

1. A method of detecting for degradation of optical channels in an optical fiber communication system, the method comprising:
(a) heterodyne sampling an optical signal with light from a light source that changes frequency over time at a constant slope;
(b) pausing the sampling of step (a);
(c) following step (b), heterodyne sampling, by frequency hopping, the optical signal with light from the light source;
(d) concurrent with step (c), sampling, by a controller, a response of the optical signal to each frequency hop in step (c); and
(e) in response to at least one sample step (d) being determined by the controller to be outside of a predetermined tolerance or range for the sample, the controller generating an error signal.

2. The method of claim 1, wherein step (a) includes continuously, periodically or aperiodically sampling and comparing each sample in step (a) to a predetermined tolerance or range for the sample.

3. The method of claim 1, further comprising:
(f) following step (d) or step (e), resuming the sampling of step (a).

4. The method of claim 3, further comprising:
(g) repeating steps (b) – (f) at least once.

5. The method of claim 3, wherein, in step (f), the sampling is resumed at a frequency that overlaps a frequency of the sampling when the sampling was paused in step (b).

6. The method of claim 3, wherein each instance of step (b) occurs after a period of sampling in step (a) or a period of sampling following step (f).

7. The method of claim 6, wherein each instance of the period of sampling in step (a) or step (f) is the same.

8. The method of claim 6, wherein each instance of the period of sampling in step (a) or step (f) is different.

9. The method of claim 1, wherein a difference between adjacent frequency hops in step (c) is the same.

10. The method of claim 1, wherein a difference between adjacent frequency hops in step (c) is different.

11. An optical channel monitor (OCM) programmed, operative and/or configured to perform a method comprising:
(a) heterodyne sampling an optical signal with light from a light source that changes frequency over time at a constant slope;
(b) pausing the sampling of step (a);
(c) following step (b), heterodyne sampling, by frequency hopping, the optical signal with light from the light source;
(d) concurrent with step (c), sampling, by a controller, a response of the optical signal to each frequency hop in step (c); and
(e) in response to at least one sample in step (d) being determined by the controller to be outside of a predetermined tolerance or range for the sample, the controller generating an error signal.

12. The OCM of claim 11, wherein step (a) includes continuously, periodically or aperiodically sampling and comparing each sample in step (a) to a predetermined tolerance or range for the sample.

13. The OCM of claim 11, wherein the method further comprises:
(f) following step (d) or step (e), resuming the sampling of step (a).

14. The OCM of claim 11, wherein the method further comprises:
(g) repeating steps (b) – (f) at least once.

15. The OCM of claim 13, wherein, in step (f), the sampling is resumed at a frequency that overlaps a frequency of the sampling when the sampling was paused in step (b).

16. The OCM of claim 13, wherein each instance of step (b) occurs after a period of sampling in step (a) or a period of sampling following step (f).

17. The OCM of claim 16, wherein each instance of the period of sampling in step (a) or step (f) is the same.

18. The OCM of claim 16, wherein each instance of the period of in step (a) or step (f) is different.

19. The OCM of claim 11, wherein a difference between adjacent frequency hops in step (c) is the same.

20. The OCM of claim 11, wherein a difference between adjacent frequency hops in step (c) is different.
